(19) United States
(12) Patent Application Publication
(10) Pub. No.: US 2011/0135181 A1
(43) Pub. Date: Jun. 9, 2011

(54) POLYNOMIAL FITTING BASED SEGMENTATION ALGORITHM FOR PULMONARY NODULE IN CHEST RADIOGRAPH

(76) Inventors: Jiayong Yan, Shanghai (CN); Mantao Xu, Shanghai (CN); Jiwu Zhang, Shanghai (CN)

(21) Appl. No.: 13/055,147

(22) PCT Filed: Aug. 26, 2008
(86) PCT No.: PCT/CN2008/001528

§ 371 Date: Jan. 21, 2011

(51) Int. Cl. G06K 9/00; G06K 9/34

(52) U.S. Cl. 382/131; 382/173

(57) ABSTRACT

The present invention has disclosed a segmentation algorithm for pulmonary nodule in chest radiograph, which comprises applying ray-casting approach on an image to get cast rays; fitting the intensity profile of each cast ray by using a polynomial curve; smoothing the polynomial curves; and searching two edge pixels in each smoothed curves. With this invention, possible edge of nodules in a chest radiograph can be identified robustly and efficiently.

### FIELD OF THE INVENTION

The invention relates generally to the field of image processing, and in particular to image segmentation. More specifically, the invention relates to a segmentation algorithm for pulmonary nodule in chest radiograph.

### BACKGROUND OF THE INVENTION

Lung cancer is one of leading causes of death by cancer in human being death in the world, and early detection of lung cancer can potentially save lives. Early detection of lung cancers could benefit from a successful screening program. However, due to a limitation of image quality for small nodules as well as a superposition of their surrounding anatomical structures, small pulmonary nodules in chest radiograph are often missed in diagnosis workflow. Those overseen or missed cancer cases often go untreated for a couple of years and therefore their cancer survival rates are very low. Computer aided detection (CAD) can lend clinician a tool in avoidance of the oversight of small pulmonary nodules.

Naturally, the segmentation of pulmonary nodules plays an important role in automated detection of pulmonary nodules in chest radiograph. But only a few algorithms have been developed so far for nodule segmentation due to a limited image quality of pulmonary nodules in chest radiograph. In other words, a suspicious nodule in chest radiograph is often overlapped or surrounded by anatomical noises, which poses a great difficulty for determining right edges.

A multi-threshold algorithm has been exploited in identification of the nodule regions in chest radiograph after the regions of interest were enhanced by using anatomical structure suppression filters. However, a prior contour or knowledge of the surrounding anatomical structures (e.g., ribs) must be known for the filters in advance.

Another approach is the so-called ray-casting algorithm (described in reference 1: Arnold M. R. Schilham, Bram van Ginneken, Marco Loog, “A computer-aided diagnosis system for detection of lung nodules in chest radiographs with an evaluation on a public database”, Medical Image Analysis, Vol. 10, No. 2, pp. 247-258, 2006.) by assuming that nodule edges correspond to the pixels with high value of gradients. One should remember calculation of gradient images is very sensitive to image noise. Multi-scale filters and edge focusing techniques can be applied for the sake of avoiding this sensitivity to image noise. But they are not applicable to the weak edges, which were often caused by the surrounding anatomical structures, and therefore result in a false detection of nodule contours.

### SUMMARY OF THE INVENTION

An object of the present invention is to identify possible edge of nodules in a chest radiograph robustly and efficiently.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a process of image segmentation, which comprises: applying ray-casting approach on an image to get cast rays; fitting the intensity profile of each cast ray by using a polynomial curve; smoothing the polynomial curves; and searching two edge pixels in each smoothed curves.

### BRIEF DESCRIPTION OF THE DRAWINGS

The foregoing and other objects, features, and advantages of the invention will be apparent from the following more particular description of the embodiments of the invention, as illustrated in the accompanying drawings.

The elements of the drawings are not necessarily to scale relative to each other.

FIG. 1 shows a process of the image segmentation of the present invention;

FIG. 2 shows an intensity profile and its polynomial fitting curve;

FIG. 3 shows the method of determining the polynomial order.

### DETAILED DESCRIPTION OF THE INVENTION

The following is a detailed description of the preferred embodiments of the invention, reference being made to the drawings in which the same reference numerals identify the same elements of structure in each of the several figures.

In the present invention, we first preprocess the chest radiograph according to the following formula:

L_{LN}=(L−\tilde{L})/(\tilde{L}²−(\tilde{L})²)^{1/2} (1)

where L_{LN} is a local normalized chest radiograph, L is the resized image (1024×1024 pixels) of an input chest radiograph and ˜ is a Gaussian filter with a kernel size of 25 pixels

σ_{LN}=25 (2)

A multi-scale blob detection algorithm is applied to select a number of initial candidates or seeds for suspicious nodules. The main purpose for blob detection is to identify all the suspicious regions indicating pulmonary nodules, in which the center of suspicious region and the scale size of the corresponding blob can be determined meanwhile. Once if the resized image is locally normalized in terms of (1), the nodule edge was further strengthened by using zero-crossings of the resulting normalized image L_{LN} through:

$${L}^{*} = \sum \{ \begin{matrix}- {α}_{1} {L}_{LN} & if {L}_{LN} < 0 \\ {α}_{2} {L}_{LN} & otherwise\end{matrix} \qquad ( 3 )$$

where α₁ and α₂ are predefined positive constants that are selected by 1 and 50 respectively in the experiments and L* represents the processed result.

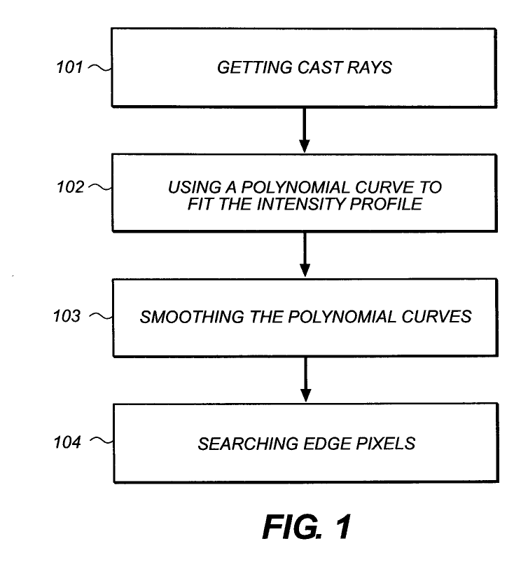

Then we cast 30 rays, in a region of interest with a homogeneous orientation distribution through the central pixel (step 101 in FIG. 1). The range of each cast ray line z in search for the edge point should be a line segment, [c−3r, c+3r], where r is the vector pointing from central pixel c to the blob boundary pixel, r, which can be identified in blob detection. An intensity profile of cast ray can be constructed by a sampling of image intensities over the ray segment z.

Instead of computing the gradients, which is used in reference 1, we fit the intensity profile of each cast ray by using a polynomial curve C (step 102 in FIG. 1), the order of which is determined with a method described latter. The main advantage of using polynomial fitting hinges on its good estimation of change of image intensities across an object boundary since it is not sensitive to most of noises appearing nearby the boundary. But most of pulmonary nodules appear in a shape of blob, where the pixels inside blob are much brighter than those in the surrounding. We can assume that the detected blob should be located inside the actual boundary of pulmonary nodule. Thus, we can limit the search for edge point in two distinct subsets of [c−3r, c−3r], namely, z_{L}=[c−r, c−3r] (i.e., the ray segment left to the central pixel) and z_{R}=[c+r, c+3r] (i.e., the ray segment right to the central pixel).

We first seek two pixels, g_{L} and g_{R}, in the ray segments, z_{L}, and z_{R}, such that they are the local minimum points of the fitted curve C but they are nearest to the central pixel c amongst all the minimum points respectively. However, in many cases, a significant fitting error may appear for the pixels nearby an isolated noise or a strong noise pixel. This inevitably leads to a strong noise in the resulting segmented contour accordingly. Hence the resulting two pixels, g_{L} and g_{R}, could be further refined by using a smoothed profile (step 103 in FIG. 1) using:

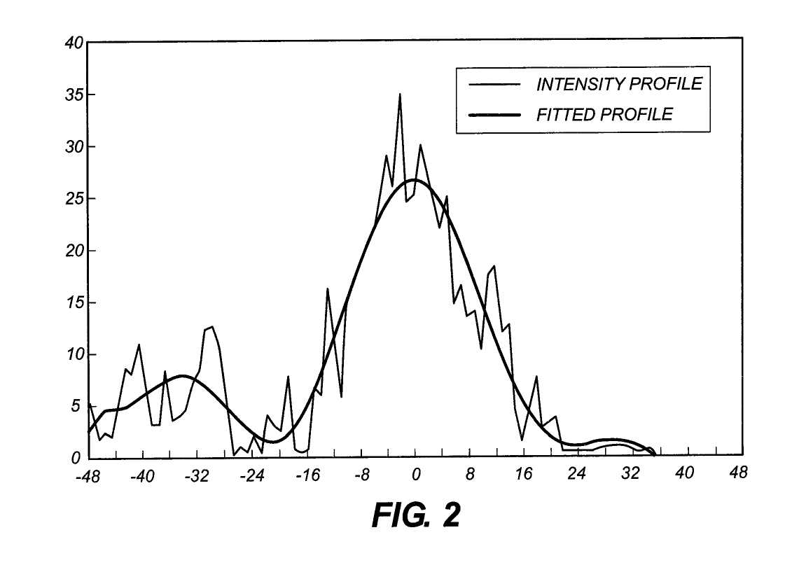

I_{smoothed}=I_{prfile}+w*(I_{profile}−I_{fit}) (4)

where I_{profile} represents the profile of the intensity of the cast ray, I_{fit} represents the fitted cast ray, w is a weighting parameter, which is set to be 0.1 and using:

$${g}_{L}^{*} = {arg min}_{x ∈ [ {g}_{L} , c - r ]} {I}_{profile} ( x ) \\ {g}_{R}^{*} = {arg min}_{x ∈ [ {g}_{R} , c + r ]} {I}_{profile} ( x ) \qquad ( 5 )$$

where g*_{L} and g*_{R} are the resulting edge pixels in left hand side and right hand side of central pixel c respectively such that they have the lowest smoothed intensity I_{smoothed} respectively in the two segments [g_{L}, c−r] and [g_{R}, c+r] (step 104 in FIG. 1). Then the list of resulting boundary points obtained the ray-casting algorithm must be smoothed by a median filtering. The thinner curve in FIG. 2 is an example of the original intensity profile for cast ray while the thicker one is its corresponding polynomial fitted curve C.

A common problem in polynomial curve fitting is that the order of polynomial curve is seldom known in practice, which is also the number of parameters to be estimated. However, the number of parameters plays an important role in statistical learning of a given dataset. This is because the likelihood of fitting a dataset is monotonically increased with the number of model parameters or the order of polynomial curve. In particular, an inappropriately large number of parameters will inevitably lead to a serious overfitting problem. To alleviate this problem, one can applies a statistical criterion in order estimation; for example, one can design an algorithm for selecting an optimal order of polynomial curves by using Bayesian Information Criterion (BIC):

$$BIC = - n ln ( \frac{RSS}{n} ) + k ln ( n ) \qquad ( 6 )$$

where RSS is the summation polynomial fitting errors, n is the number of sampling points, and k is the order to be estimated.

In this work, a simple and fast technique for optimal order selection is introduced according to the BIC in (6) that can exploit the inherited structures in the profile of cast rays to the benefit of nodule segmentation. In theory, the optimal order could be the minimum or a local minimum of the BIC curve, which is plotted as a function of the polynomial order. However, the monotonicity of the likelihood of polynomial fitting increased with the number of model parameters still makes it difficult to select a best polynomial order such that BIC is minimized.

We applied a fast and simple algorithm for selecting the optimal order of polynomial fitting, which includes the following steps:

1. For each kε[3,n/10], Compute the sampled BIC values according to (6)

2. Calculate the minimum and maximum of the BIC curve respectively according to:

$$a = {arg max}_{k} BIC ( k ) and b = {arg min}_{k} BIC ( k )$$

3. Fit the subsample {(BIC(k),k)|k=a, . . . b} by 3-order polynomial and line respectively: curve f(k) and line g(k).

4. Find k such that (7) is satisfied∘

$${k}_{selected} = {arg min}_{k ∈ [ a , b ]} ( f ( k ) - g ( k ) ) \qquad ( 7 )$$

where a and b is the maximum and minimum of the sampled BIC values.

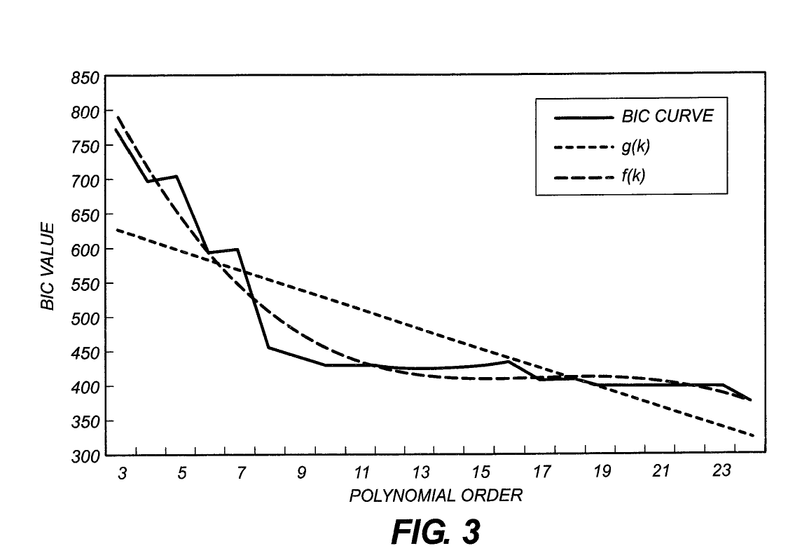

It is demonstrated in FIG. 3. This algorithm first fits the sampled BIC curve (the real line) by using 3-order polynomial and line respectively, f(k) (the short dashed) and g(k) (the long dashed), and then the optimal order is selected such that the difference of f(k) and g(k) is maximized according to (7).

The present invention provides a polynomial fitting based ray-casting algorithm for pulmonary nodule segmentation in chest radiograph. The initial experiment results have shown that the polynomial fitting based algorithm is very robust and efficient in comparison with the original ray casting algorithm based on gradient features.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed is:

1. A process of image segmentation, which comprises:
applying ray-casting approach on a image to get cast rays;
fitting the intensity profile of each cast ray by using a polynomial curve;
smoothing the polynomial curves; and
searching two edge pixels in each smoothed curves.

2. The process of claim 1, wherein the order of the polynomial curve is obtained by the following steps:
for each kε[3,n/10], Computing the sampled BIC values according to the following formula:
$$BIC = - n ln ( \frac{RSS}{n} ) + k ln ( n )$$
where BIC is Bayesian Information Criterion, RSS is the summation polynomial fitting errors, n is the number of sampling points, and k is the order to be estimated;
calculating the minimum and maximum of the BIC curve respectively according to:
$$a = {arg max}_{k} BIC ( k ) and b = {arg min}_{k} BIC ( k )$$
fitting the subsample {(BIC(k),k)|k=a, . . . b} by 3-order polynomial and line respectively: curve f(k) and line g(k);
finding k such that the following formula is satisfied:
$${k}_{selected} = {arg min}_{k ∈ [ a , b ]} ( f ( k ) - g ( k ) )$$

3. The process of claim 1, wherein the image is obtained by the following steps:
processing a resized image according to the following formula:
L_{LN}=(L−\tilde{L})/(\tilde{L}²−(\tilde{L})²)^{1/2}
where L_{LN} is a local normalized chest radiograph, L is the resized image of an input chest radiograph and ˜ is a Gaussian filter with a kernel size, L_{LN} is the local normalized image; and
processing the local normalized image according to the following formula:
$${L}^{*} = \sum \{ \begin{matrix}- {α}_{1} {L}_{LN} & if {L}_{LN} < 0 \\ {α}_{2} {L}_{LN} & otherwise\end{matrix}$$
where α₁ and α₂ are predefined positive constants and L* represents the processed result.

4. The process of claim 1, wherein the searching for two edge pixels is limited in the scope of [c−r, c−3r] and [c+r, c+3r], wherein c is the central pixel and r is the vector pointing from central pixel c to a blob boundary pixel.

5. The process of claim 1, wherein smoothing the polynomial curves is realized according to the following formula:
I_{smoothed}=I_{profile}+w*(I_{profile}−I_{fit})
where w is a weighting parameter.

6. The process of claim 5, wherein w is set to be 0.1.

7. The process of claim 5, wherein resulting edge pixels can be obtained according to the following formula:
$${g}_{L}^{*} = {arg min}_{x ∈ [ {g}_{L} , c - r ]} {I}_{profile} ( x )$$
$${g}_{R}^{*} = {arg min}_{x ∈ [ {g}_{R} , c + r ]} {I}_{profile} ( x )$$
wherein g*_{L} and g*_{R} are the resulting edge pixels in left hand side and right hand side of central pixel c.

8. The process of claim 7, the list of resulting edge pixels can be smoothed by a median filtering.

9. The process of claim 1 includes applying a multi-scale blob detection algorithm to the image.
